(19) United States
(12) Patent Application Publication
(10) Pub. No.: US 2026/0241840 A1
(43) Pub. Date: Aug. 20, 2026

(54) SYSTEM FOR SUPPORTING A PASSENGER AND A METHOD OF CONTROLLING THE SAME

(71) Applicants: HYUNDAI MOTOR COMPANY, Seoul (KR); KIA CORPORATION, Seoul (KR)

(72) Inventors: Xiao He, Yantai (CN); Zhe Li, Yantai (CN); Yan Xiang Huang, Yantai (CN); Liang Nie, Yantai (CN)

(73) Assignees: HYUNDAI MOTOR COMPANY, Seoul (KR); KIA CORPORATION, Seoul (KR)

(21) Appl. No.: 19/537,164

(22) Filed: Feb. 11, 2026

(30) Foreign Application Priority Data
Feb. 14, 2025 (CN) 202510165800.7

(51) Int. Cl. B60N 2/22; B60N 2/02

(52) U.S. Cl. CPC B60N 2/22; B60N 2/02246; B60N 2/0273; B60N 2/2222

(57) ABSTRACT

A thermal management system of a vehicle includes: a sensor device that includes a seat weight sensor configured to sense whether the passenger sits on a center seat of a rear seat of a vehicle and send passenger sensing information; a control device that is configured to determine whether the passenger sits on the center seat of the rear seat based on the passenger sensing information received from the sensor device and to selectively send a control signal according to an input of a user in response to a determination that the passenger sits on the center seat of the rear seat; and a passenger support device that is installed at a backrest of the center seat of the rear seat and includes a waist support member. The passenger support device is configured to operate the waist support member based on the control signal received from the control device so that the waist support member is stretched from the backrest toward a front of the vehicle along a longitudinal direction of the vehicle to support a waist of the passenger sitting on the center seat of the rear seat.

### CROSS-REFERENCE TO RELATED APPLICATION

This application claims priority to and the benefit of Chinese Patent Application No. 202510165800.7 filed with the Chinese National Intellectual Property Administration on Feb. 14, 2025, the entire contents of which are incorporated herein by reference.

### BACKGROUND

### (a) Technical Field

The present disclosure relates to a field of a seat of a vehicle, and more particularly, to a system for supporting a passenger capable of supporting the passenger seated in a center seat or portion of a rear seat when the vehicle rotates, and a method of controlling the same.

### (b) Description of the Related Art

As technology of a vehicle advances, people's demands for power, economy, safety, handling, and comfort of the vehicle are increasing. Generally, three seats (e.g., a left seat, a center seat, and a right seat) are provided in a rear seat of the vehicle. When the vehicle rotates during a driving process thereof, a body of a passenger is tilted to the left or right due to a centrifugal force of the vehicle. If the passenger sits on the center seat of the rear seat (i.e., if there are three passengers in the rear seat), a device for supporting the passenger's body on the center seat such as a bilateral armrest may not be generally provided in the center seat of the rear seat. This causes the passenger to collide with a passenger next to them, which causes discomfort. Thus, ride quality may be reduced.

A hidden type of armrest device capable of being unfolded to a front of the vehicle is provided in the center seat (specifically, in a backrest of the center seat) in most vehicles currently on the market. Because the center seat lacks a support structure that supports the passenger's waist portion due to the presence of the armrest device, the passenger on the center seat may easily feel uncomfortable in the waist area thereof during long-time driving of the vehicle, which causes ride fatigue to increase.

Therefore, there is a need for a device capable of supporting the passenger sitting on the center seat of the rear seat when the vehicle rotates to prevent the passenger's body from being tilted and which is capable of supporting the passenger's waist.

The above information disclosed in this Background section is only for enhancement of understanding of the background of this disclosure, and therefore it may include information that does not form the prior art that is already known to a person of ordinary skill in the art.

### SUMMARY

An embodiment of the present disclosure is intended to provide a system for supporting one side of a waist of a passenger capable of sitting on a center rear seat when a vehicle rotates, and a method of controlling the same. Another embodiment of the present disclosure is intended to provide a system for supporting both sides of a waist of a passenger sitting on the center rear seat when the vehicle is driven, and a method of controlling the same.

According to an aspect of the present disclosure, a system for supporting a passenger is provided. The system includes: a sensor device that includes a seat weight sensor configured to sense whether the passenger sits on a center seat of a rear seat (i.e., center rear seat, or center portion of a rear seat) of a vehicle and send passenger sensing information; a control device that is configured to determine whether the passenger sits on the center seat of the rear seat based on the passenger sensing information received from the sensor device and to selectively send a control signal according to an input of a user in response to determining that the passenger sits on the center seat of the rear seat; and a passenger support device that is installed at a backrest of the center seat of the rear seat and includes a waist support member. The passenger support device is configured to operate the waist support member based on the control signal received from the control device so that the waist support member is stretched from the backrest toward a front of the vehicle along a longitudinal direction of the vehicle to support a waist of the passenger sitting on the center seat of the rear seat, and the waist support member includes a left waist support member and a right waist support member.

The system may further include an interface device, wherein the interface device may include a display portion configured to display information to determine whether the waist support member is operated and an operation mode of the waist support member; and an input portion configured to receive the input of the user from the user. The operation mode may include a first operation mode and a second operation mode, the left waist support member or the right waist support member may be configured to be longitudinally stretched from the backrest toward the front of the vehicle when the vehicle rotates in the first operation mode, and the left waist support member and the right waist support member may be configured to be longitudinally stretched from the backrest toward the front of the vehicle in the second operation mode.

The sensor device may further include a yaw rate sensor and the yaw rate sensor may be configured to sense a yaw rate of the vehicle. In response to receiving the input from the user through the input portion to operate the waist support member and execute the first operation mode, the control device may be further configured to: determine whether an operation signal of a turn signal lamp and an operation signal of a steering wheel are received; determine a rotation direction of the steering wheel according to the operation signal of the steering wheel based on a determination that both the operation signal of the turn signal lamp and the operation signal of the steering wheel are received; allow the right waist support member to be longitudinally stretched toward the front of the vehicle from the backrest with a predetermined variable longitudinal elongation length based on the yaw rate of the vehicle which is sensed by the yaw rate sensor in response to a determination that the steering wheel is rotated to the left; and allow the left waist support member to be longitudinally stretched from the backrest toward the front of the vehicle with the predetermined variable longitudinal elongation length based on the yaw rate of the vehicle sensed by the yaw rate sensor in response to determining that the steering wheel is rotated to the right. The variable longitudinal elongation length may increase as the yaw rate of the vehicle increases.

In response to receiving the input from the user through the input portion to operate the waist support member and execute the second operation mode, the control device may be further configured to allow each of the left waist support member and the right waist support member to be longitudinally stretched from the backrest toward the front of the vehicle with a predetermined fixed longitudinal elongation length.

In response to receiving the input from the user through the input portion to cancel the operation of the waist support member, the control device may be further configured not to execute an elongation operation of the waist support member.

The control device may be further configured to: determine whether the steering wheel is returned to an original position of the steering wheel according to the operation signal of the steering wheel; and allow the right waist support member or the left waist support member having longitudinally stretched to be returned to the backrest based on a determination that the steering wheel is returned to the original position of the steering wheel.

In response to receiving the input from the user through the input portion to stop the operation of the waist support member, the control device may be further configured to allow the left waist support member and the right waist support member having longitudinally stretched to be returned to the backrest.

The passenger support device may include an upper connection portion, an operation portion, and a lower connection portion. The upper connection portion may be installed at a backrest frame of the backrest. The operation portion may include a bracket, a pair of transversal movement members, a motor assembly, a first guide assembly, a pair of longitudinal movement members, and a plurality of pairs of second guide assemblies. An upper end of the bracket may be detachably connected to a lower end of the upper connection portion. The pair of transversal movement members may be moved in opposite directions in a transverse direction of the vehicle and a first rack and a second rack may be provided in each of the pair of transversal movement members. The motor assembly may include at least one motor and at least one output gear connected to an output axis of the at least one motor, the output gear may be engaged with the corresponding first rack, and the motor may rotate the output gear based on the control signal received from the control device so that the first rack engaged with the output gear is moved along the transverse direction of the vehicle and the corresponding transversal movement member is moved along the transverse direction. The first guide assembly may be installed at the bracket and may guide the transversal movement member to be moved in the transverse direction and at least a portion of the transversal movement member may be inserted into the first guide assembly. Each of the pair of longitudinal movement members may be movable in the longitudinal direction, and a third rack may be provided in each of the pair of longitudinal movement members, wherein the pair of longitudinal movement members may be connected to the waist support member. The plurality of pairs of second guide assemblies may be installed at the bracket, a transmission gear may be provided in each of the plurality of pairs of second guide assemblies, at least a portion of the transversal movement member and at least a portion of the longitudinal movement member may be inserted into the corresponding second guide assembly, wherein the transmission gear may be engaged with the corresponding second rack and the corresponding third rack, and each of the plurality of pairs of second guide assemblies, based on a movement in the transverse direction, may be configured to cause the corresponding longitudinal movement member to move in the longitudinal direction so that the corresponding waist support member is stretched in the longitudinal direction toward the front of the vehicle along the longitudinal direction. An upper end of the lower connection portion may be detachably connected to a lower end of the bracket.

The first guide assembly may include an installation plate and a first cylindrical guide portion and a second cylindrical guide portion disposed at a first side of the installation plate, stretched in the transverse direction. An opening may be provided at a central portion of a second side of the installation plate in the transverse direction, and a position of the opening may correspond to positions of the first cylindrical guide portion and the second cylindrical guide portion so that the corresponding first rack is exposed to the outside through the opening. The motor assembly may be installed at the second side of the installation plate, and a position of the motor assembly may correspond to the position of the opening so that the output gear is engaged with the corresponding first rack. The first cylindrical guide portion and the second cylindrical guide portion may be parallel to each other at a predetermined distance in a vertical direction, and a sliding groove may be provided inside each of the first cylindrical guide portion and the second cylindrical guide portion.

The pair of transversal movement members may include a first transversal movement member and a second transversal movement member. Each of the first transversal movement member and the second transversal movement member may include an intermediate transversal movement portion and an upper branch transversal movement portion and a lower branch transversal movement portion branched from the intermediate transversal movement portion. The first rack may be provided in the intermediate transversal movement portion, the second rack may be provided in the upper branch transversal movement portion and the lower branch transversal movement portion, and a first sliding block may be provided at each of one sides of the upper branch transversal movement portion and the lower branch transversal movement portion opposite to the second rack. The intermediate transversal movement portion of the first transversal movement member may be inserted into the first cylindrical guide portion in a first direction, the intermediate transversal movement portion of the second transversal movement member may be inserted into the second cylindrical guide portion in a second direction opposite to the first direction, and the first rack of the first transversal movement member and the first rack of the second transversal movement member may be each engaged with the corresponding output gear.

Each of the plurality of pairs of second guide assemblies may include: a first sliding guide groove configured to guide the upper branch transversal movement portion or the lower branch transversal movement portion to move in the transverse direction; a second sliding guide groove configured to guide the longitudinal movement member to move in the longitudinal direction; and a transmission gear provided between the first sliding guide groove and the second sliding guide groove, wherein the first sliding guide groove and the second sliding guide groove may be disposed with guide directions perpendicular to each other at both sides of the transmission gear.

One pair of the plurality of pairs of second guide assemblies may respectively correspond to the upper branch transversal movement portion and the lower branch transversal movement portion of the first transversal movement member, and another pair of the plurality of pairs of second guide assemblies may respectively correspond to the upper branch transversal movement portion and the lower branch transversal movement portion of the second transversal movement member.

The pair of longitudinal movement members may include a first longitudinal movement member and a second longitudinal movement member, wherein each of the first longitudinal movement member and the second longitudinal movement member may include an intermediate longitudinal movement portion, an upper longitudinal movement portion and a lower longitudinal movement portion that are perpendicular to the intermediate longitudinal movement portion and are respectively connected to upper and lower ends of the intermediate longitudinal movement portion. The third rack may be provided in the upper longitudinal movement portion and the lower longitudinal movement portion. A second sliding block may be provided at each of one sides of the upper longitudinal movement portion and the lower longitudinal movement portion opposite to the third rack. Each of the first sliding block of the upper branch transversal movement portion and the first sliding block of the lower branch transversal movement portion may be inserted into the corresponding first sliding guide groove, and each of the second sliding block of the upper longitudinal movement portion and the second sliding block of the lower longitudinal movement portion may be inserted into the corresponding second sliding guide groove. Each of the second rack of the upper branch transversal movement portion and the second rack of the lower branch transversal movement portion may be engaged with the corresponding transmission gear, and each of the third rack of the upper longitudinal movement portion and the third rack of the lower longitudinal movement portion may be engaged with the corresponding transmission gear.

According to another aspect of the present disclosure, a method of controlling the system for supporting the passenger is provided. The method includes: sensing whether the passenger sits on a center seat of a rear seat of a vehicle by a seat weight sensor and sending passenger sensing information; determining whether the passenger sits on the center seat of the rear seat based on the passenger sensing information received from the seat weight sensor by a control device; selectively sending a control signal according to an input of a user by the control device in response to a determination that the passenger sits on the center seat of the rear seat; and operating a waist support member included in a passenger support device based on the control signal received from the control device by the passenger support device. In the operating of the waist support member, the waist support member is longitudinally stretched from a backrest of the center seat of the rear seat toward a front of the vehicle along a longitudinal direction of the vehicle to support a waist of the passenger sitting on the center seat of the rear seat, and the passenger support device is installed at the backrest of the center seat of the rear seat. The waist support member includes a left waist support member and a right waist support member.

The method may further include: displaying information to determine whether the waist support member is operated and an operation mode of the waist support member by a display portion; and receiving the input of the user by an input portion. The operation mode includes a first operation mode and a second operation mode, and the left waist support member or the right waist support member is configured to be longitudinally stretched from the backrest toward the front of the vehicle only when the vehicle rotates in the first operation mode. The left waist support member and the right waist support member are configured to be longitudinally stretched from the backrest toward the front of the vehicle in the second operation mode.

The method may further include: determining whether an operation signal of a turn signal lamp and an operation signal of a steering wheel are received by the control device in response to receiving the input from the user through the input portion to operate the waist support member and execute the first operation mode; determining a rotation direction of the steering wheel according to the operation signal of the steering wheel by the control device based on a determination that both the operation signal of the turn signal lamp and the operation signal of the steering wheel are received; allowing the right waist support member to be longitudinally stretched from the backrest toward the front of the vehicle with a predetermined variable longitudinal elongation length by the control device based on a yaw rate of the vehicle, wherein the yaw rate is sensed by a yaw rate sensor in response to a determination that the steering wheel is rotated to the left; and allowing the left waist support member to be longitudinally stretched from the backrest toward the front of the vehicle with the predetermined variable longitudinal elongation length by the control device based on the yaw rate of the vehicle sensed by the yaw rate sensor in response to a determination that the steering wheel is rotated to the right. The variable longitudinal elongation length may increase as the yaw rate of the vehicle increases.

The method may further include allowing each of the left waist support member and the right waist support member to be longitudinally stretched from the backrest toward the front of the vehicle with a predetermined fixed longitudinal elongation length by the control device in response to receiving the input from the user through the input portion for operating the waist support member and executing the second operation mode.

The method may further include not executing an elongation operation of the waist support member by the control device in response to receiving the input from the user through the input portion for canceling the operation of the waist support member.

The method may further include: determining, by the control device, whether the steering wheel is returned to an original position of the steering wheel according to the operation signal of the steering wheel; and allowing, by the control device, the right waist support member or the left waist support member that have been longitudinally stretched to return to the backrest based on a determination that the steering wheel is returned to the original position of the steering wheel.

The method may further include allowing, by the control device, the left waist support member and the right waist support member that have been longitudinally stretched to return to the backrest in response to receiving the input from the user through the input portion to stop the operation of the waist support member.

An embodiment of the present disclosure may prevent a passenger from being tilted to the left or the right due to rotation of a vehicle by supporting one side of a waist of the passenger sitting on a center seat of a rear seat when the vehicle rotates so that it improves ride comfort.

An embodiment of the present disclosure may support both sides of the waist of the passenger sitting on the center seat of the rear seat when the vehicle is driven to reduce fatigue of the waist and ride fatigue.

In addition, an effect obtained or predicted by an embodiment of the present disclosure is disclosed directly or implicitly in a detailed description of the present disclosure. In other words, various effects predicted according to an embodiment of the present disclosure are disclosed in the detailed description below.

### BRIEF DESCRIPTION OF THE DRAWINGS

Hereinafter, an embodiment of the present disclosure is described in more detail with reference to the drawings. For clarity, the same members in different drawings are denoted by the same reference numerals. It should be noted that the drawings are illustrative and are not necessarily drawn to scale.

FIG. 1 is a block diagram of a system for supporting a passenger according to an embodiment of the present disclosure.

FIG. 2 is a schematic diagram showing an appearance in which a passenger support device of the system for supporting the passenger according to an embodiment of the present disclosure is installed at a rear seat.

FIG. 3 is a schematic diagram showing a structure in which the passenger support device according to an embodiment of the present disclosure is installed at the rear seat.

FIG. 4 is a perspective view of the passenger support device according to an embodiment of the present disclosure.

FIG. 5 is an exploded view of the passenger support device according to an embodiment of the present disclosure.

FIG. 6 is a perspective view of a second guide member of the passenger support device according to an embodiment of the present disclosure.

FIG. 7 is a cross-sectional view taken along line A-A of FIG. 6.

FIG. 8 is a cross-sectional view taken along line B-B of FIG. 6.

FIG. 9 is a perspective view of a first guide member of the passenger support device according to an embodiment of the present disclosure.

FIG. 10 is a cross-sectional view taken along line C-C of FIG. 9.

FIG. 11 is a cross-sectional view taken along line D-D of FIG. 9.

FIG. 12 is a perspective view of a passenger support device according to another embodiment of the present disclosure.

FIG. 13 and FIG. 14 are flowcharts of a method of controlling the system for supporting the passenger according to an embodiment of the present disclosure.

FIG. 15 is a flowchart of a process for determining an elongation length of a left waist support member or a right waist support member of FIG. 14, according to an embodiment of the present disclosure.

It should be understood that the drawings simply show each feature in order to describe a basic principle of the present disclosure and are not necessarily drawn according to a ratio. A specific design feature (e.g., a specific size, a specific direction, a specific position, or a specific shape) disclosed in the present disclosure is partly determined by an environment in which the present disclosure is applied and used.

In the drawings, a same reference symbol indicates a same or equivalent part of the present disclosure.

### DETAILED DESCRIPTION

Hereinafter, each embodiment of the present disclosure is described in detail, and an embodiment is illustrated in the drawings. Although the present disclosure is described in combination with the disclosed embodiments, it should be understood that the present specification is not intended to limit the present disclosure to the disclosed embodiments. The present disclosure includes not only the disclosed embodiments but also various selection forms, modification forms, equivalent forms, and other embodiments within the spirit of the present disclosure and the scope of the appended claims.

When one element is referred to as being “connected” to another element, the one element is directly or indirectly connected to the other element, and the indirect connection includes connection through a wireless communication network.

When a component, controller, device, element, apparatus, unit or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, or the like may separately embody or be included with one or more processors and a memory, such as a non-transitory computer-readable media, as part of the apparatus. The one or more processors may be configured to implement computer-readable instructions stored in the memory to perform the described operations.

It may be understood that the term “comprises” used in an embodiment means presence of a feature, a numerical value, a step, an operation, an element, and/or a component but does not exclude presence or addition of one or more other features, numerical values, steps, operations, elements, components, and/or combinations thereof.

In the present specification, terms such as “first” and “second” may be used to describe each element, but it is understood that the element is not limited by the terms.

Hereinafter, an operation principle and an embodiment of the present disclosure is described in detail with reference to the accompanying drawings.

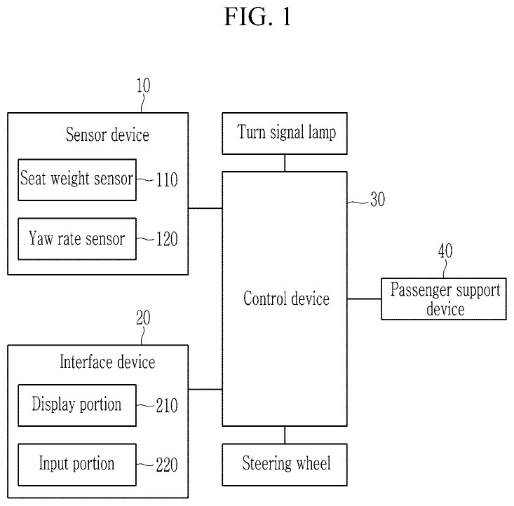

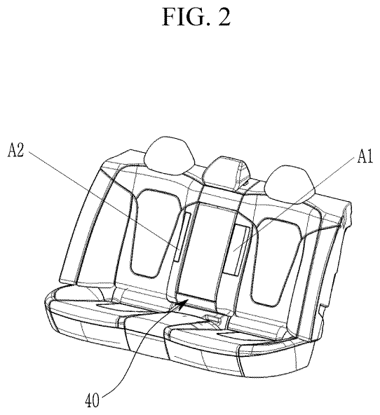

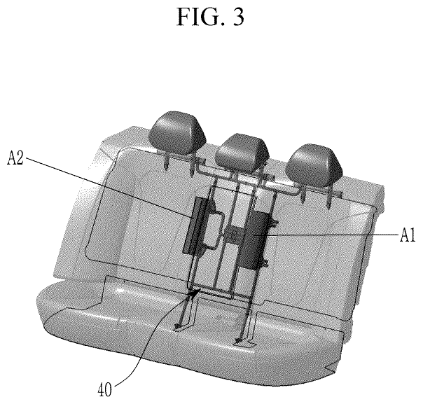

FIG. 1 is a block diagram of a system for supporting a passenger according to an embodiment of the present disclosure, FIG. 2 is a schematic diagram showing an appearance in which a passenger support device of the system for supporting the passenger according to an embodiment of the present disclosure is installed at a rear seat, and FIG. 3 is a schematic diagram showing a structure in which the passenger support device according to an embodiment of the present disclosure is installed at the rear seat.

Referring to FIG. 1, the system for supporting the passenger according to an embodiment of the present disclosure may include a sensor device 10, an interface device 20, a control device 30, and a passenger support device 40. The sensor device 10 may include a seat weight sensor 110. The seat weight sensor 110 may be installed on a seat of a vehicle, and may be configured to sense whether the passenger sits on a center seat of the rear seat of the vehicle and send passenger sensing information.

The control device 30 may be configured to determine whether the passenger sits on the center seat of the rear seat based on the passenger sensing information received from the sensor device 10 (more specifically, the seat weight sensor 110). In response to a determination that the passenger sits on the center seat of the rear seat, the control device 30 may selectively send a control signal to the passenger support device 40 according to a user's input to control an operation of the passenger support device 40. The control device 30 may include a communication device, a memory, and one or more processors. The communication device may communicate with another device or another sensor to control a function of the device, the memory may store an operating system, a logic command, or input/output information, and the one or more processors may execute determination, an operation, or strategy necessary for controlling the function. According to the embodiment of the present disclosure, the control device 30 may include a head unit (HU), but the embodiment of the present disclosure is not limited thereto.

Referring to FIG. 2 and FIG. 3, the passenger support device 40 may be installed at a backrest of the center seat of the rear seat, and may include a waist support member. The waist support member may include a left waist support member A1 and a right waist support member A2. The passenger support device 40 may operate at least one of the left waist support member A1 and the right waist support member A2 based on the control signal received from the control device 30, so that the left waist support member A1 and/or the right waist support member A2 are stretched from the backrest of the center seat of the rear seat toward the front of the vehicle along a longitudinal direction of the vehicle. Accordingly, the left waist support member A1 and/or the right waist support member A2 may support a waist of the passenger sitting on the center seat of the rear seat. According to an embodiment of the present disclosure, the control device 30 may independently control the left waist support member A1 or the right waist support member A2.

According to an embodiment of the present disclosure, the passenger support device 40 may be inserted into the backrest of the center seat of the rear seat in parallel with the backrest of the center seat of the rear seat. The left waist support member A1 and the right waist support member A2 may be installed at a left edge and a right edge of the backrest of the center seat of the rear seat respectively, and their heights may align with a waist region of the passenger sitting on the center seat of the rear seat. Outer surfaces of the left waist support member A1 and the right waist support member A2 may be made of a material that matches a material of a seat skin of the vehicle, and may have an appearance that matches an appearance of the backrest of the center seat of the rear seat. Therefore, if the left waist support member A1 and the right waist support member A2 are not in an elongation state (i.e., if the left waist support member A1 and the right waist support member A2 are in a returned state), the left waist support member A1 and the right waist support member A2 may be completely fused with the backrest of the center seat of the rear seat to maintain a fine view of the seat.

The interface device 20 may include a display portion 210 and an input portion 220. The display portion 210 may be configured to display information for determining whether the waist support member is operated and an operation mode of the waist support member, and the input portion 220 may be configured to receive an input from the user. The input portion 220 may include a key, an operation stick, a knob, or the like. Additionally, the input portion 220 may include a soft keyboard implemented in the display portion 210. If a touch sensor such as a touch film, a touch sheet, or a touch panel is included in the display portion 210, the display portion 210 may be operated as a touch screen, and the input portion 220 and the display portion 210 may be implemented as an integrated type. The display portion 210 may include at least one of a liquid crystal display (LCD), a thin film transistor liquid crystal display (TFT-LCD), an organic light emitting diode (OLED), a flexible display, a field emission display (FED), and a three-dimensional (3D) display. According to an embodiment of the present disclosure, the display portion 210 and the input portion 220 may be integrated into the control device 30.

The operation mode according to an embodiment of the present disclosure may include a first operation mode and a second operation mode. In the first operation mode, the left waist support member A1 or the right waist support member A2 may be longitudinally stretched from the backrest of the center seat of the rear seat toward the front of the vehicle when the vehicle rotates, and in the second operation mode, the left waist support member A1 and the right waist support member A2 may be longitudinally stretched from the backrest toward the front of the vehicle immediately.

For example, according to an embodiment of the present disclosure, if the control device 30 determines that the passenger sits on the center seat of the rear seat using the seat weight sensor 110 in a start state or a current-carrying state of the vehicle, the control device 30 may send a control command to the display portion 210 to control the display portion 210 to display the information for determining whether the waist support member is operated and the operation mode of the waist support member, and may receive the input of the user from an inputter through the input portion 220. If the input of the user for operating the waist support member and executing the first operation mode (i.e., a mode in which the left waist support member A1 or the right waist support member A2 is longitudinally stretched from the backrest of the center seat of the rear seat toward the front of the vehicle when the vehicle rotates) is received from the user through the input portion 220, the control device 30 may operate the left waist support member A1 or the right waist support member A2 based on a rotation direction when the vehicle rotates.

In some embodiments, if the user input for operating the waist support member and executing the first operation mode is received from the user through the input portion 220, the control device 30 may determine whether an operation signal of a turn signal lamp and an operation signal of a steering wheel are received. In response to a determination that both the operation signal of the turn signal lamp and the operation signal of the steering wheel are received, the control device 30 may determine that the vehicle will rotate. In this case, the control device 30 may determine the rotation direction when the vehicle rotates according to the operation signal of the steering wheel. For example, in response to a determination that the steering wheel is rotated to the left based on the operation signal of the steering wheel, the control device 30 may determine that the vehicle rotates to the left. In this case, the control device 30 may control only the right waist support member A2 to be longitudinally stretched from the backrest of the center seat of the rear seat toward the front of the vehicle. In response to determining that the steering wheel is rotated to the right based on the operation signal of the steering wheel, the control device 30 may determine that the vehicle rotates to the right. In this case, the control device 30 may control only the left waist support member A1 to be longitudinally stretched from the backrest toward the front of the vehicle. The left waist support member A1 or the right waist support member A2 may be controlled to be longitudinally stretched from the backrest of the center seat of the rear seat toward the front of the vehicle based on the operation signal of the steering wheel, and the left or the right of the passenger's waist portion may be supported to prevent the passenger sitting on the center seat of the rear seat from being tilted to the left or the right due to rotation of the vehicle. In this example, a left turn of the steering wheel may mean that the steering wheel is rotated counterclockwise from a driver's perspective, and this may correspond to the vehicle's heading changing direction to the left. A right turn of the steering wheel may mean that the steering wheel is rotated clockwise from the driver's perspective, and may correspond to the vehicle's heading changing direction to the right.

Additionally, the system for supporting the passenger according to an embodiment of the present disclosure may control the left waist support member A1 or the right waist support member A2 by considering a yaw rate when the vehicle rotates so that the left waist support member A1 or the right waist support member A2 is longitudinally stretched from the backrest of the center seat of the rear seat toward the front of the vehicle with a variable longitudinal elongation length.

To this end, the sensor device 10 may further include a yaw rate sensor 120. The yaw rate sensor 120 may be installed at the vehicle, and may be configured to sense a yaw rate of the vehicle. According to an embodiment of the present disclosure, the yaw rate sensor 120 may be realized using a yaw rate sensor of an electronic stability program (ESP) system, but an embodiment of the present disclosure is not limited thereto.

For example, if the yaw rate of the vehicle is sensed to be less than or equal to a first threshold value (e.g., 6366 rad/h that corresponds to a driving speed of 20 km/h) through the yaw rate sensor 120, the control device 30 may predict that the passenger's body tilt is relatively small, so the control device 30 operates the left waist support member A1 or the right waist support member A2 to be longitudinally stretched from the backrest of the center seat of the rear seat toward the front of the vehicle with a first elongation length (e.g., 40 mm).

If the yaw rate of the vehicle is sensed to be greater than the first threshold value and less than or equal to a second threshold value (e.g., 9549 rad/h that corresponds to a driving speed of 30 km/h) through the yaw rate sensor 120, the control device 30 may predict that the passenger's body tilt is relatively large, so the control device 30 operates the left waist support member A1 or the right waist support member A2 to be longitudinally stretched from the backrest of the center seat of the rear seat toward the front of the vehicle with a second elongation length (e.g., 50 mm).

If the yaw rate of the vehicle is sensed to be greater than the second threshold value through the yaw rate sensor 120, the control device 30 may predict that the passenger's body tilt is large so that the control device 30 operates the left waist support member A1 or the right waist support member A2 to be longitudinally stretched from the backrest of the center seat of the rear seat toward the front of the vehicle with a third elongation length (e.g., 60 mm).

Variable longitudinal elongation lengths may be differently controlled based on the yaw rate when the vehicle rotates to ensure that sufficient support is provided to one side of the waist of the passenger sitting on the center seat of the rear seat. Accordingly, the passenger may be prevented from being tilted to the left or the right due to rotation of the vehicle.

If the left waist support member A1 or the right waist support member A2 is in the elongation state, the control device 30 may monitor whether the steering wheel is returned to an original position of the steering wheel based on the operation signal of the steering wheel. In response to a determination that the steering wheel has already been returned to its original position, the control device 30 may operate the left waist support member A1 or the right waist support member A2 so that the left waist support member A1 or the right waist support member A2 that is longitudinally stretched is returned to the backrest.

If the display portion 210 displays the information to determine whether the waist support member is operated and the operation mode of the waist support member, the user input for operating the waist support member and executing the second operation mode (i.e., a mode in which the left waist support member A1 and the right waist support member A2 are immediately longitudinally stretched from the backrest of the center seat of the rear seat toward the front of the vehicle) may be received from the user through the input portion 220. In this case, the control device 30 may operate the left waist support member A1 and the right waist support member A2 so that each of the left waist support member A1 and the right waist support member A2 is immediately longitudinally stretched from the backrest of the center seat of the rear seat toward the front of the vehicle with a fixed longitudinal elongation length (e.g., 50 mm).

In this case, if the left waist support member A1 and the right waist support member A2 are in the elongation state, the control device 30 may monitor the user input or a driving state of the vehicle. If the user input for stopping an operation of the waist support member is received from the user through the input portion 220, the control device 30 may operate the left waist support member A1 and the right waist support member A2 so that the left waist support member A1 and the right waist support member A2 that are longitudinally stretched are returned to the backrest. Alternatively, in response to determining that start of the vehicle is turned off or electric power of the vehicle is cut off, the control device 30 may operate the left waist support member A1 and the right waist support member A2 so that the left waist support member A1 and the right waist support member A2 that are longitudinally stretched are returned to the backrest.

By simultaneously controlling the left waist support member A1 and the right waist support member A2 to be longitudinally stretched from the backrest of the center seat of the rear seat toward the front of the vehicle with the fixed longitudinal elongation length when the vehicle is driven, it is possible to reduce the passenger's ride fatigue by supporting both sides of the waist of the passenger sitting on the center seat.

If an input for canceling the operation of the waist support member is received from the user through the input portion 220 when the display portion 210 displays the information to determine whether the waist support member is operated and the operation mode of the waist support member, the control device 30 may not execute elongation operations of the left waist support member A1 and the right waist support member A2. In this case, the left waist support member A1 and the right waist support member A2 may be maintained at the backrest of the center seat of the rear seat.

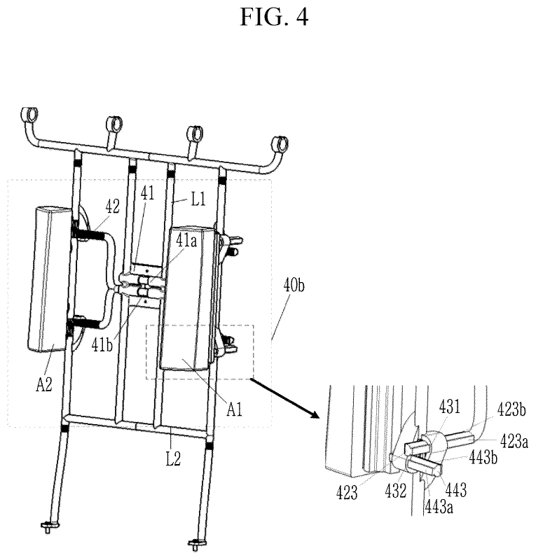

Hereinafter, a structure of the passenger support device 40 according to an embodiment of the present disclosure is described in detail with reference to FIGS. 4-11.

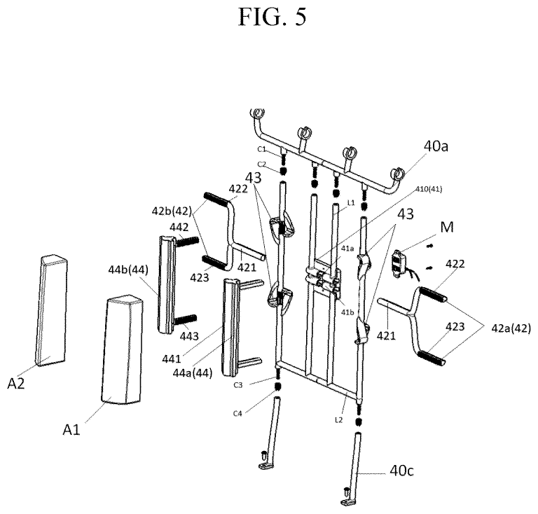

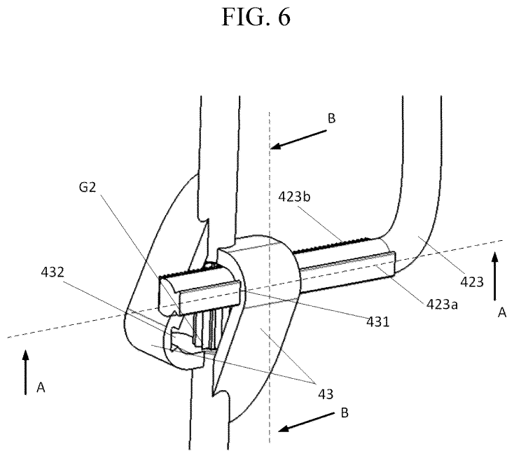

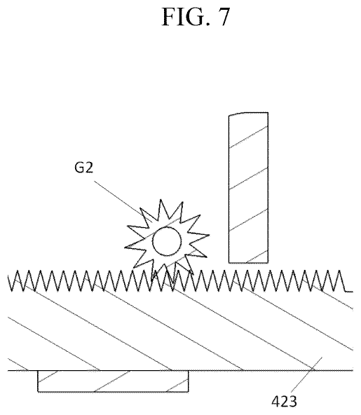

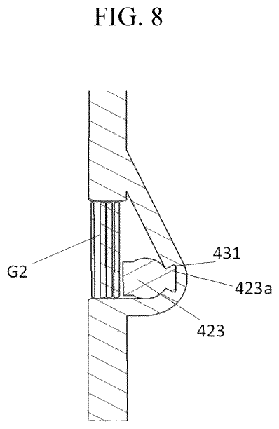

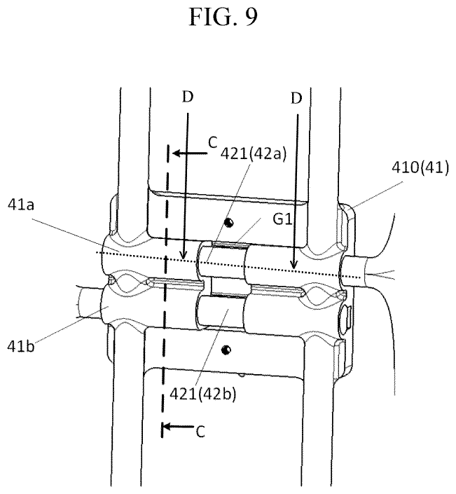

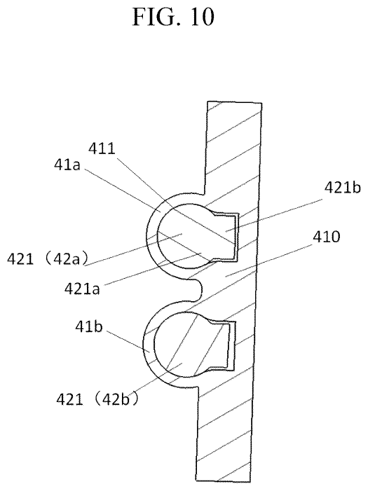

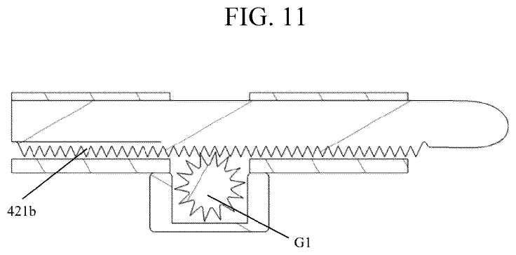

FIG. 4 is a perspective view of the passenger support device according to an embodiment of the present disclosure, FIG. 5 is an exploded view of the passenger support device according to an embodiment of the present disclosure, FIG. 6 is a perspective view of a second guide member of the passenger support device according to an embodiment of the present disclosure, FIG. 7 is a cross-sectional view taken along line A-A of FIG. 6, FIG. 8 is a cross-sectional view taken along line B-B of FIG. 6, FIG. 9 is a perspective view of a first guide member of the passenger support device according to an embodiment of the present disclosure, FIG. 10 is a cross-sectional view taken along line C-C of FIG. 9, and FIG. 11 is a cross-sectional view taken along line D-D of FIG. 9.

As shown in FIG. 4 and FIG. 5, the passenger support device 40 may include an upper connection portion 40a, an operation portion 40b, and a lower connection portion 40c. An upper end of the upper connection portion 40a may have a plurality of circular clamping structures disposed at predetermined intervals along a transverse direction of the vehicle, and an upper portion of the circular clamping structure may have an opening. A plurality of first connection members C1 (for example, connection bolts) may be provided at a lower end of the upper connection portion 40a. The upper connection portion 40a may be installed at a backrest frame of the backrest of the center seat of the rear seat and backrest frames of backrests of seats on both sides of the rear seat through the plurality of circular clamping structures. A second connection member C2 (for example, a connection bolt) corresponding to the first connection member C1 may be provided at an upper end of the operation portion 40b, and the upper connection portion 40a may be detachably connected to the operation portion 40b through connection between the first connection member C1 and the second connection member C2. A pair of third connection members C3 (e.g., connection bolts) may be provided at a lower end of the operation portion 40b. A fourth connection member C4 (for example, a connection bolt) corresponding to the third connection member C3 may be provided at an upper end of the lower connection portion 40c, and the lower connection portion 40c may be detachably connected to the operation portion 40b through connection between the third connection member C3 and the fourth connection member C4. A lower end of the lower connection portion 40c may be installed at a floor of a lower side of the rear seat through a screw. According to an embodiment of the present disclosure, the upper connection portion 40a and the lower connection portion 40c may be separated from the operation portion 40b. The upper connection portion 40a and the lower connection portion 40c may be individually designed according to different types of vehicles, and the operation portion 40b may be shared among different types of vehicles. However, a material and an appearance of an outer surface of each of the right support member A1 and the left support member A2 may be specifically adjusted according to an actual situation of the center seat of the rear seat. Thus, according to an embodiment of the present disclosure, research and development and manufacturing cost of the passenger support device 40 may be significantly reduced.

For example, according to an embodiment of the present disclosure, the operation portion 40b may include a bracket, and the bracket may include a plurality of vertical support bars L1 disposed at predetermined intervals along the transverse direction and a horizontal support bar L2 disposed below the plurality of vertical support bars L1. The second connection member C2 may be provided at an upper end of each of the plurality of vertical support bars L1, and the third connection member C3 may be provided at a lower end of each of a leftmost vertical support bar L1 (e.g., a leftmost vertical support bar of FIG. 4 and FIG. 5) and a rightmost vertical support bar L1 (e.g., a rightmost vertical support bar in FIG. 4 and FIG. 5) among the plurality of vertical support bars L1.

Additionally, the operation portion 40b may include a first guide assembly 41, a transversal movement member 42 guided by the first guide assembly 41 to be moved in the transverse direction, and a motor assembly M that provides power for movement of the transversal movement member 42.

Referring to FIG. 4 and FIG. 5, the first guide assembly 41 may be installed at a pair of vertical support bars L1 disposed at a middle position among the plurality of vertical support bars L1. Additionally, referring to FIG. 9 and FIG. 10, the first guide assembly 41 may include an installation plate 410 and a first cylindrical guide portion 41a and a second cylindrical guide portion 41b stretched in a transverse direction from the installation plate 410. The first and second cylindrical guide portion 41a and 41b may be installed parallel to each other at a predetermined distance in a vertical direction.

Referring to FIG. 4 and FIG. 5, the transversal movement member 42 may include a first transversal movement member 42a and a second transversal movement member 42b provided in opposite directions. Each of the first transversal movement member 42a and the second transversal movement member 42b may include an intermediate transversal movement portion 421, an upper branch transversal movement portion 422 and a lower branch transversal movement portion 423 that are branched from the intermediate transversal movement portion 421. The intermediate transversal movement portion 421 of the first transversal movement member 42a may be inserted into the first cylindrical guide portion 41a and the intermediate transversal movement portion 421 of the second transversal movement member 42b may be inserted into the second cylindrical guide portion 41b so that the first transversal movement member 42a and the second transversal movement member 42b move in opposite directions.

For example, referring to FIGS. 9-11, a sliding groove 411 may be provided inside each of the first cylindrical guide portion 41a and the second cylindrical guide portion 41b, and a sliding portion 421a corresponding to the sliding groove 411 may be provided on one side of the intermediate transversal movement portion 421 so that the sliding portion 421a slides along the sliding groove 411. A first rack 421b may be provided on the other side of the intermediate transversal movement portion 421 opposite to the sliding portion 421a.

As shown in FIGS. 6-8, a first sliding block 423a may be provided at one side of the lower branch transversal movement portion 423, and a second rack 423b may be provided at one side opposite to the first sliding block 423a. Correspondingly, the upper branch transversal movement portion 422 may have the same structure as that of the lower branch transversal movement portion 423.

As illustrated in FIGS. 9-11, an opening may be provided in a transverse direction center of one side of the installation plate 410 opposite to the first cylindrical guide portion 41a and the second cylindrical guide portion 41b, so that the first rack 421b of the intermediate transversal movement portion 421 of the first transversal movement member 42a and the first rack 421b of the intermediate transversal movement portion 421 of the second transversal movement member 42b are exposed to the outside.

According to an embodiment of the present disclosure, the motor assembly M may include at least one motor and at least one output gear G1 connected to an output axis of the motor. For example, in an embodiment of the present disclosure, the motor assembly M may include a housing, the motor may be disposed in the housing, and the output gear G1 may be disposed in the housing so that at least a portion of the output gear G1 is exposed to the outside. In some embodiments, two motors may be provided, and one output gear G1 may be correspondingly connected to each motor. As shown in FIGS. 9-11, two output gears G1 may be exposed to the outside.

The motor assembly M may be installed at one side of the installation plate 410 opposite to the first cylindrical guide portion 41a and the second cylindrical guide portion 41b, and each output gear G1 may be engaged with a corresponding first rack 421b by corresponding to a position of the opening.

According to an embodiment of the present disclosure, if a motor corresponding to the first transversal movement member 42a inserted into the first cylindrical guide portion 41a is rotated in a first rotation direction, the output gear G1 connected to the motor may be rotated according to rotation of the motor, and the first transversal movement member 42a may be moved to a first side (e.g., a right side of FIG. 5) in the transverse direction of the vehicle through engagement between the output gear G1 and the first rack 421b. If a motor corresponding to the second transversal movement member 42b inserted into the second cylindrical guide portion 41b is rotated in a second rotation direction opposite to the first rotation direction, the output gear G1 connected to the motor may be rotated according to rotation of the motor, and the second transversal movement member 42b may be moved to a second side (e.g., a left side of FIG. 5) in the transverse direction of the vehicle through engagement between the output gear G1 and the first rack 421b. In other words, depending on rotation of the motors, the first transversal movement member 42a and the second transversal movement member 42b may be moved away from each other in opposite directions. In addition, rotation directions of the motors may be controlled so that the first transversal movement member 42a is moved to the second side (e.g., the left side of FIG. 5) in the transverse direction of the vehicle and the second transversal movement member 42b is moved to the first side (e.g., the right side of FIG. 5) in the transverse direction of the vehicle. Alternatively, the motor may be individually controlled so that one of the first transversal movement member 42a and the second transversal movement member 42b is moved.

Referring to FIG. 4 and FIG. 5, the operation portion 40b may further include a second guide assembly 43 provided in a plurality of pairs and a pair of longitudinal movement members 44 that are guided by a plurality of pairs of second guide assemblies 43 to be moved in the longitudinal direction of the vehicle.

A pair of second guide assemblies 43 among the plurality pairs of second guide assemblies 43 may be installed at the rightmost vertical support bar L1 (e.g., the rightmost vertical support bar of FIG. 5) among the plurality of vertical support bars L1, and may correspond to the upper branch transversal movement portion 422 and the lower branch transversal movement portion 423 of the first transversal movement member 42a. Another pair of second guide assemblies 43 among the plurality of pairs of second guide assemblies 43 may be installed at the leftmost vertical support bar L1 (e.g., the leftmost vertical support bar of FIG. 5) among the plurality of vertical support bars L1, and may correspond to the upper branch transversal movement portion 422 and the lower branch transversal movement portion 423 of the second transversal movement member 42b.

As illustrated in FIGS. 6-8, each of the plurality of pairs of second guide assemblies 43 may include a first sliding guide groove 431 for guiding the upper branch transversal movement portion 422 or the lower branch transversal movement portion 423 to be moved in the transverse direction, a second sliding guide groove 432 for guiding the longitudinal movement member to be moved in the longitudinal direction, and a transmission gear G2 installed between the first sliding guide groove 431 and the second sliding guide groove 432. The first sliding guide groove 431 and the second sliding guide groove 432 may have guide directions that are perpendicular to each other, and may be provided at both sides of the transmission gear G2.

Referring to FIG. 4 and FIG. 5, the pair of longitudinal movement members 44 may include a first longitudinal movement member 44a and a second longitudinal movement member 44b. Each of the first longitudinal movement member 44a and the second longitudinal movement member 44b may include an intermediate longitudinal movement portion 441, and also an upper longitudinal movement portion 442 and a lower longitudinal movement portion 443 that are perpendicular to the intermediate longitudinal movement portion 441 and are respectively connected to upper and lower end portions of the intermediate longitudinal movement portion 441.

The upper longitudinal movement portion 442 and the lower longitudinal movement portion 443 of the first longitudinal movement member 44a may be each inserted longitudinally into the pair of second guide assemblies 43 on the rightmost vertical support bar L1 among the plurality of vertical support bars L1. The upper longitudinal movement portion 442 and the lower longitudinal movement portion 443 of the second longitudinal movement member 44b may be each inserted longitudinally into the pair of second guide assemblies 43 on the leftmost vertical support bar L1 among the plurality of vertical support bars L1. The upper branch transversal movement portion 422 and the lower branch transversal movement portion 423 of the first transversal movement member 42a may be each transversely inserted into the pair of second guide assemblies 43 on the rightmost vertical support bar L1 among the plurality of vertical support bars L1. The upper branch transversal movement portion 422 and the lower branch transversal movement portion 423 of the second transversal movement member 42b may be each transversely inserted into the pair of second guide assemblies 43 on the leftmost vertical support bar L1 among the plurality of vertical support bars L1.

According to an embodiment of the present disclosure, the lower longitudinal movement portion 443 may have the same structure as that of the lower branch transversal movement portion 423. For example, as shown in FIG. 4 and FIG. 5, a second sliding block 443a may be provided at one side of the lower longitudinal movement portion 443, and a third rack 443b may be provided at one side opposite to the second sliding block 443a. Correspondingly, the upper longitudinal movement portion 442 may have the same structure as that of the lower longitudinal movement portion 443.

For example, as illustrated in FIG. 4 and FIG. 6, taking one of the plurality pairs of second guide assemblies 43 as an example, the second sliding block 443a of the lower longitudinal movement portion 443 may be inserted into the second sliding guide groove 432 to slide along the second sliding guide groove 432, and the first sliding block 423a of the lower branch transversal movement portion 423 may be inserted into the first sliding guide groove 431 to slide along the first sliding guide groove 431. At the same time, the third rack 443b of the lower longitudinal movement portion 443 and the second rack 423b of the lower branch transversal movement portion 423 may be each engaged with the transmission gear G2.

Accordingly, through a structure of the second guide assembly 43, the transmission gear G2 that is engaged with the second rack 423b of the lower branch transversal movement portion 423 of the first transversal movement member 42a may be rotated if the first transversal movement member 42a is moved in the transverse direction to the first side by driving of the motor, and the third rack 443b of the lower longitudinal movement portion 443 of the first longitudinal movement member 44a that is engaged with the transmission gear G2 may be moved forward in the longitudinal direction according to the rotation of the transmission gear G2. At the same time, the transmission gear G2 that is engaged with the second rack of the upper branch transversal movement portion 422 of the first transversal movement member 42a may be rotated, and as the transmission gear G2 is rotated, the third rack 443b of the upper longitudinal movement portion 442 of the first longitudinal movement member 44a that is engaged with the transmission gear G2 may be moved forward in the longitudinal direction so that a forward movement of the first longitudinal movement member 44a is realized. Similarly, if the second transversal movement member 42b is moved in the transverse direction to the second side by driving of the motor, the second longitudinal movement member 44b may be moved forward along the longitudinal direction. Thus, it is possible to realize that the right support member A1 and/or the left support member A2 are longitudinally stretched from the backrest of the center seat of the rear seat toward the front of the vehicle along the longitudinal direction of the vehicle.

For example, as shown in FIG. 4 and FIG. 5, the right support member A1 and the left support member A2 may be included in the operation portion 40b, each of the right support member A1 and the left support member A2 may be connected to the intermediate longitudinal movement portion 441 of the first longitudinal movement member 44a and the intermediate longitudinal movement portion 441 of the second longitudinal movement member 44b, and the right support member A1 and the left support member A2 may cover an outer surface of the intermediate longitudinal movement portion 441 to form a surface that is in contact with the passenger sitting on the center seat of the rear seat.

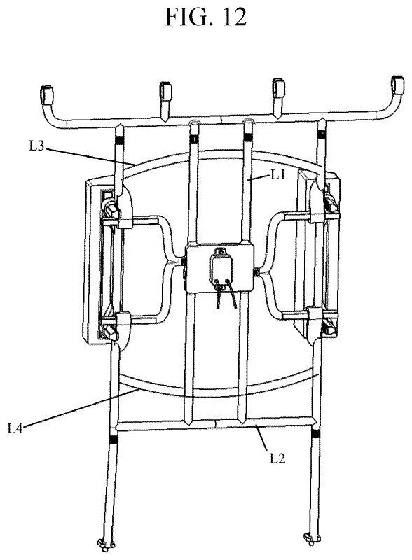

FIG. 12 is a perspective view of a passenger support device according to another embodiment of the present disclosure.

As shown in FIG. 12, the passenger support device 40 may add an upper transverse direction support bar L3 and a lower transverse direction support bar L4 on a bracket, and for example, each of the upper transverse direction support bar L3 and the lower transverse direction support bar L4 may have an arc shape, but the present disclosure is not limited thereto.

The upper transverse direction support bar L3 and the lower transverse direction support bar L4 may be respectively disposed at upper and lower sides of the right support member A1 and the left support member A2, may be integrally formed with the bracket to increase structural rigidity of the passenger support device 40, may effectively resist deformation of the passenger support device 40, and may increase deformation resistance to realize a reinforcement effect.

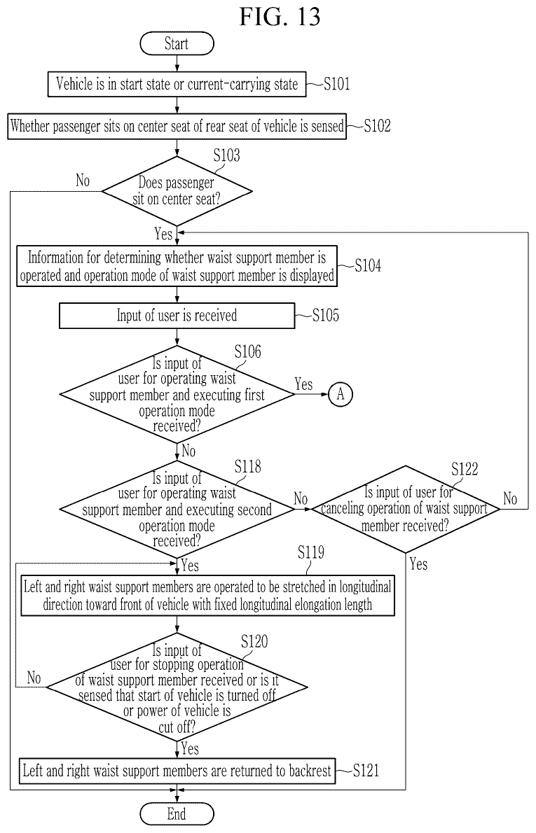

Hereinafter, a method of controlling the system for supporting the passenger according to an embodiment of the present disclosure is described with reference to FIGS. 13-15.

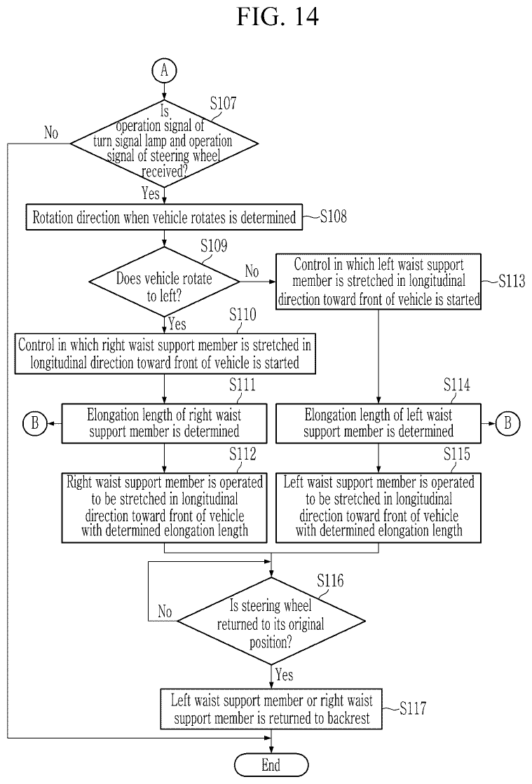

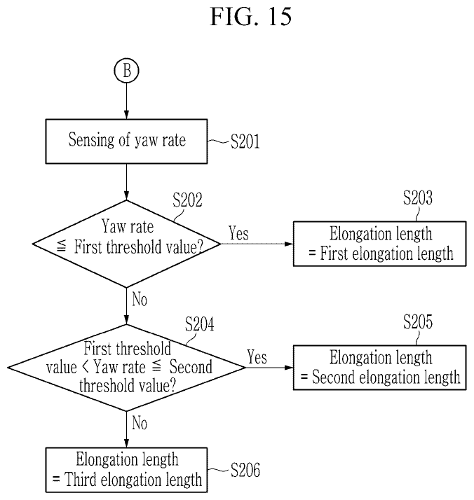

FIG. 13 and FIG. 14 are flowcharts of the method of controlling the system for supporting the passenger according to an embodiment of the present disclosure. FIG. 15 is a flowchart of a process for determining an elongation length of the left waist support member or the right waist support member of FIG. 14.

As shown in FIG. 13 and FIG. 14, in a start state or a current-carrying state of the vehicle (S101), the control device 30 may send a control command requesting to sense whether the passenger sits on the center seat of the rear seat of the vehicle through the seat weight sensor 110 (S102).

In a step S103, the control device 30 may determine whether the passenger sits on the center seat of the rear seat based on passenger sensing information received from the seat weight sensor 110.

In response to determining that the passenger sits on the center seat of the rear seat (Yes in the step S103), the control device 30 may send the control command to the display portion 210 to control the display portion 210 to display the information to determine whether the waist support member is operated and the operation mode of the waist support member, in a step S104.

In a step S105, the control device 30 may receive the input of the user through the input portion 220.

In a step S106, the control device 30 may determine whether the user input for operating (or manipulating) the waist support member and executing the first operation mode is received.

If the user input for operating the waist support member and executing the first operation mode is received (Yes in the step S106), the control device 30 may determine whether the operation signal of the turn signal lamp and the operation signal of the steering wheel are received, in a step S107.

If the operation signal of the turn signal lamp and the operation signal of the steering wheel are received (Yes in the step S107), the control device 30 may determine the rotation direction when the vehicle rotates according to the operation signal of the steering wheel in a step S108.

If the operation signal of the turn signal lamp or the operation signal of the steering wheel is not received (No in the step S107), the control device 30 may terminate the control method.

In a step S109, the control device 30 may determine whether the vehicle rotates to the left.

In response to determining that the vehicle rotates to the left (Yes in the step S109), in a step S110, the control device 30 may start control in which the right waist support member A2 is longitudinally stretched from the backrest of the center seat of the rear seat toward the front of the vehicle.

In a step S111, the control device 30 may determine an elongation length of the right waist support member A2.

In a step S112, the control device 30 may operate the right waist support member A2 to be longitudinally stretched from the backrest of the center seat of the rear seat toward the front of the vehicle with a determined elongation length.

In response to a determination that the vehicle is not rotated to the left (No in the step S109), the control device 30 may start control in which the left waist support member A1 is longitudinally stretched from the backrest of the center seat of the rear seat toward the front of the vehicle in a step S113.

In a step S114, the control device 30 may determine an elongation length of the left waist support member A1.

In a step S115, the control device 30 may operate the left waist support member A1 to be longitudinally stretched from the backrest of the center seat of the rear seat toward the front of the vehicle with a determined elongation length.

In a step S116, the control device 30 may monitor whether the steering wheel is returned to its original position based on the operation signal of the steering wheel.

In response to a determination that the steering wheel has already returned to its original position (Yes in the step S116), the control device 30 may operate the left waist support member A1 or the right waist support member A2 so that the left waist support member A1 or the right waist support member A2 stretched in the longitudinal direction is returned to the backrest, in a step S117.

If the user input for operating the waist support member and executing the first operation mode is not received (No in the step S106), the control device 30 may determine whether the user input for operating the waist support member and executing the second operation mode is received in a step S118.

If the user input for operating the waist support member and executing the second operation mode is received (Yes in the step S118), the control device 30 may operate the left waist support member A1 and the right waist support member A2 to be longitudinally stretched from the backrest of the center seat of the rear seat toward the front of the vehicle with the fixed longitudinal elongation length, in a step S118.

In the step S120, the control device 30 may determine whether the user input for stopping the operation of the waist support member is received from the user through the input portion 220 or whether start (or ignition) of the vehicle turned off or electric power of the vehicle cut off is sensed.

If the user input for stopping the operation of the waist support member is received or it is determined that the start of the vehicle is turned off or the power of the vehicle is cut off (Yes in the step S120), in a step S121, the control device 30 may operate the left waist support member A1 and the right waist support member A2 so that the left waist support member A1 and the right waist support member A2 longitudinally stretched are returned to the backrest.

If the user input for stopping the operation of the waist support member is not received or it is determined that the start of the vehicle is not turned off or the power of the vehicle is not cut off (No in the step S120), the control device 30 may continue executing the step S119.

If the user input for operating the waist support member and executing the second operation mode is not received (No in the step S118), the control device 30 may determine whether the user input for canceling the operation of the waist support member is received in a step S122.

If the user input for canceling the operation of the waist support member is received (Yes in the step S122), the control device 30 may terminate the control method.

If the user input for canceling the operation of the waist support member is not received (No in the step S122), the control device 30 may continue executing the step S104.

In response to a determination that there is no passenger in the center seat of the rear seat (No in the step S103), the control device 30 may terminate the control method.

When the elongation length of the left waist support member A1 or the right waist support member A2 is determined, as illustrated in FIG. 15, in a step S201, the control device 30 may send a control command requesting the yaw rate sensor 120 to sense the yaw rate of the vehicle.

In a step S202, the control device 30 may determine whether the yaw rate is less than or equal to the first threshold value based on the yaw rate of the vehicle received from the yaw rate sensor 120.

In response to a determination that the yaw rate is less than or equal to the first threshold value (Yes in the step S202), the control device 30 may determine the elongation length as the first elongation length, in a step S203.

In response to a determination that the yaw rate is not less than or equal to the first threshold value (No in the step S202), the control device 30 may determine whether the yaw rate is greater than the first threshold value and less than or equal to the second threshold value, in a step S204.

In response to a determination that the yaw rate is greater than the first threshold value and less than or equal to the second threshold value (Yes in the step S204), the control device 30 may determine the elongation length as the second elongation length, in a step S205.

In response to a determination that the yaw rate is not greater than the first threshold value and not less than or equal to the second threshold value (No in the step S204), the control device 30 may determine the elongation length as the third elongation length in a step S206.

The system for supporting the passenger and the method of controlling the system for supporting the passenger according to embodiments may prevent the passenger from being tilted to the left or the right due to rotation of the vehicle by supporting one side of the waist of the passenger sitting on the center seat of the rear seat when the vehicle rotates so that they improve ride comfort. In addition, the system for supporting the passenger and the method of controlling the system for supporting the passenger may support both sides of the waist of the passenger sitting on the center seat of the rear seat when the vehicle is being driven so that they reduce fatigue of the waist and ride fatigue.

For clarity of description, the method of the present disclosure described above is expressed as a series of operations, but the present disclosure is not intended to limit an order of execution steps, and the steps may be executed simultaneously or in a different order as necessary. In order to implement the method according to the present disclosure, the steps may additionally include another step, may include the remaining steps excluding some of the steps, or may include another additional step excluding some of the steps.

The present disclosure may be implemented by hardware, firmware, software, or a combination thereof. The hardware may be implemented by one or more of an application specific integrated circuit (ASIC), a digital signal processor (DSP), a digital signal processing device (DSPD), a programmable logic device (PLD), a field programmable gate array (FPGA), a general-purpose processor, a controller, a microcontroller, and a microprocessor.

A scope of the present disclosure may include software or a machine-executable instruction (e.g., an operating system, an application, firmware, or a program) that allows an operation according to various embodiments to be executed on a device or a computer, and a nonvolatile computer readable medium in which the software or the instruction is stored to be executed on the device or the computer.

While this disclosure has been described in connection with what is presently considered to be a practical embodiment, it should be understood that the disclosure is not limited to a disclosed embodiment, but, on the contrary, is intended to cover various modifications and equivalent arrangements included within the spirit and scope of the appended claims.

What is claimed is:

1. A system for supporting a passenger, the system comprising:
a sensor device that includes a seat weight sensor configured to sense whether the passenger sits on a center seat of a rear seat of a vehicle and also configured to send passenger sensing information;
a control device that is configured to determine whether the passenger sits on the center seat of the rear seat based on the passenger sensing information received from the sensor device and further configured to selectively send a control signal according to an input of a user in response to a determination that the passenger sits on the center seat of the rear seat; and
a passenger support device that is installed at a backrest of the center seat of the rear seat and includes a waist support member,
wherein the passenger support device is configured to operate the waist support member based on the control signal received from the control device so that the waist support member is stretched from the backrest toward a front of the vehicle along a longitudinal direction of the vehicle to support a waist of the passenger sitting on the center seat of the rear seat, and
wherein the waist support member includes a left waist support member and a right waist support member.

2. The system of claim 1, further comprising an interface device,
wherein the interface device comprises:
a display portion configured to display information to determine whether the waist support member is operated and an operation mode of the waist support member; and
an input portion configured to receive the input of the user from the user,
wherein the operation mode includes a first operation mode and a second operation mode, the left waist support member or the right waist support member being configured to be longitudinally stretched from the backrest toward the front of the vehicle based on the vehicle rotating in the first operation mode, and
wherein the left waist support member and the right waist support member are configured to be longitudinally stretched from the backrest toward the front of the vehicle in the second operation mode.

3. The system of claim 2, wherein the sensor device further includes a yaw rate sensor, the yaw rate sensor being configured to sense a yaw rate of the vehicle,
wherein, based on receiving the input from the user through the input portion for operating the waist support member and executing the first operation mode, the control device is further configured to:
determine whether an operation signal of a turn signal lamp and an operation signal of a steering wheel are received;
determine a rotation direction of the steering wheel according to the operation signal of the steering wheel based on a determination that both the operation signal of the turn signal lamp and the operation signal of the steering wheel are received;
allow the right waist support member to be longitudinally stretched toward the front of the vehicle from the backrest with a predetermined variable longitudinal elongation length based on the yaw rate of the vehicle sensed by the yaw rate sensor, in response to a determination that the steering wheel is rotated to the left; and
allow the left waist support member to be longitudinally stretched from the backrest toward the front of the vehicle with the predetermined variable longitudinal elongation length based on the yaw rate of the vehicle sensed by the yaw rate sensor in response to a determination that the steering wheel is rotated to the right, and
wherein the variable longitudinal elongation length increases as the yaw rate of the vehicle increases.

4. The system of claim 2, wherein, based on receiving the input from the user through the input portion for operating the waist support member and executing the second operation mode, the control device is further configured to allow each of the left waist support member and the right waist support member to be longitudinally stretched from the backrest toward the front of the vehicle with a predetermined fixed longitudinal elongation length.

5. The system of claim 2, wherein, based on receiving the input from the user through the input portion for canceling the operation of the waist support member, the control device is further configured not to execute an elongation operation of the waist support member.

6. The system of claim 3, wherein the control device is further configured to:
determine whether the steering wheel is returned to an original position of the steering wheel according to the operation signal of the steering wheel; and
allow the right waist support member or the left waist support member having longitudinally stretched to be returned to the backrest based on a determination that the steering wheel is already returned to the original position of the steering wheel.

7. The system of claim 4, wherein, based on receiving the input from the user through the input portion to stop the operation of the waist support member being received from the user, the control device is further configured to allow the left waist support member and the right waist support member having longitudinally stretched to be returned to the backrest.

8. The system of claim 1, wherein the passenger support device comprises an upper connection portion, an operation portion, and a lower connection portion, the upper connection portion being installed at a backrest frame of the backrest;
wherein the operation portion includes a bracket, a pair of transversal movement members, a motor assembly, a first guide assembly, a pair of longitudinal movement members, and a plurality of pairs of second guide assemblies;
wherein an upper end of the bracket is detachably connected to a lower end of the upper connection portion;
wherein the pair of transversal movement members are moved in opposite directions in a transverse direction of the vehicle and a first rack and a second rack are provided in each of the pair of transversal movement members;
wherein the motor assembly includes at least one motor and at least one output gear connected to an output axis of the at least one motor, wherein the output gear is engaged with the corresponding first rack, and the motor rotates the output gear based on the control signal received from the control device so that the first rack engaged with the output gear is moved along the transverse direction of the vehicle and the corresponding transversal movement member is moved along the transverse direction;
wherein the first guide assembly is installed at the bracket and guides the transversal movement member to be moved in the transverse direction and at least a portion of the transversal movement member is inserted into the first guide assembly;
wherein each of the pair of longitudinal movement members is movable in the longitudinal direction, a third rack is provided in each of the pair of longitudinal movement members, and the pair of longitudinal movement members are connected to the waist support member;
wherein the plurality of pairs of second guide assemblies are installed at the bracket, a transmission gear is provided in each of the plurality of pairs of second guide assemblies, at least a portion of the transversal movement member and at least a portion of the longitudinal movement member are inserted into the corresponding second guide assembly, the transmission gear is engaged with the corresponding second rack and the corresponding third rack,
wherein each of the plurality of pairs of second guide assemblies, based on a movement in the transverse direction, is configured to cause the corresponding longitudinal movement member to move in the longitudinal direction so that the corresponding waist support member is stretched in the longitudinal direction toward the front of the vehicle along the longitudinal direction; and
wherein an upper end of the lower connection portion is detachably connected to a lower end of the bracket.

9. The system of claim 8, wherein the first guide assembly includes an installation plate and a first cylindrical guide portion, and a second cylindrical guide portion disposed at a first side of the installation plate and stretched in the transverse direction;
wherein an opening is provided at a central portion of a second side of the installation plate in the transverse direction, and a position of the opening corresponds to positions of the first cylindrical guide portion and the second cylindrical guide portion so that the corresponding first rack is exposed to the outside through the opening;
wherein the motor assembly is installed at the second side of the installation plate, and a position of the motor assembly corresponds to the position of the opening so that the output gear is engaged with the corresponding first rack; and
wherein the first cylindrical guide portion and the second cylindrical guide portion are parallel to each other at a predetermined distance in a vertical direction, and a sliding groove is provided inside each of the first cylindrical guide portion and the second cylindrical guide portion.

10. The system of claim 9, wherein the pair of transversal movement members include a first transversal movement member and a second transversal movement member;
wherein each of the first transversal movement member and the second transversal movement member includes an intermediate transversal movement portion and an upper branch transversal movement portion and a lower branch transversal movement portion branched from the intermediate transversal movement portion;
wherein the first rack is provided in the intermediate transversal movement portion, the second rack is provided in both the upper branch transversal movement portion and the lower branch transversal movement portion, and a first sliding block is provided at each of the sides of the upper branch transversal movement portion and the lower branch transversal movement portion opposite to the second rack; and
wherein the intermediate transversal movement portion of the first transversal movement member is inserted into the first cylindrical guide portion in a first direction, the intermediate transversal movement portion of the second transversal movement member is inserted into the second cylindrical guide portion in a second direction opposite to the first direction, and the first rack of the first transversal movement member and the first rack of the second transversal movement member are each engaged with the corresponding output gear.

11. The system of claim 10, wherein each of the plurality pairs of second guide assemblies includes:
a first sliding guide groove configured to guide the upper branch transversal movement portion or the lower branch transversal movement portion to move in the transverse direction;
a second sliding guide groove configured to guide the longitudinal movement member to move in the longitudinal direction; and
a transmission gear provided between the first sliding guide groove and the second sliding guide groove,
wherein the first sliding guide groove and the second sliding guide groove are disposed with guide directions perpendicular to each other at both sides of the transmission gear.

12. The system of claim 11, wherein a pair of the plurality of pairs of second guide assemblies respectively correspond to the upper branch transversal movement portion and the lower branch transversal movement portion of the first transversal movement member, and another pair of the plurality of pairs of second guide assemblies respectively correspond to the upper branch transversal movement portion and the lower branch transversal movement portion of the second transversal movement member.

13. The system of claim 12, wherein the pair of longitudinal movement members include a first longitudinal movement member and a second longitudinal movement member;
wherein each of the first longitudinal movement member and the second longitudinal movement member includes an intermediate longitudinal movement portion and an upper longitudinal movement portion and a lower longitudinal movement portion that are perpendicular to the intermediate longitudinal movement portion and are respectively connected to upper and lower ends of the intermediate longitudinal movement portion;
wherein the third rack is provided in the upper longitudinal movement portion and the lower longitudinal movement portion;
wherein a second sliding block is provided at each of the sides of the upper longitudinal movement portion and the lower longitudinal movement portion opposite to the third rack;
wherein each of the first sliding block of the upper branch transversal movement portion and the first sliding block of the lower branch transversal movement portion is inserted into the corresponding first sliding guide groove, and each of the second sliding block of the upper longitudinal movement portion and the second sliding block of the lower longitudinal movement portion is inserted into the corresponding second sliding guide groove; and
wherein each of the second rack of the upper branch transversal movement portion and the second rack of the lower branch transversal movement portion is engaged with the corresponding transmission gear, and each of the third rack of the upper longitudinal movement portion and the third rack of the lower longitudinal movement portion is engaged with the corresponding transmission gear.

14. A method of controlling a system for supporting a passenger, comprising:
sensing whether the passenger sits on a center seat of a rear seat of a vehicle by a seat weight sensor and sending passenger sensing information;
determining whether the passenger sits on the center seat of the rear seat based on the passenger sensing information received from the seat weight sensor by a control device;
selectively sending a control signal according to an input of a user by the control device based on a determination that the passenger sits on the center seat of the rear seat; and
operating a waist support member included in a passenger support device based on the control signal received from the control device by the passenger support device,
wherein in the operating of the waist support member, the waist support member is longitudinally stretched from a backrest of the center seat of the rear seat toward a front of the vehicle along a longitudinal direction of the vehicle to support a waist of the passenger sitting on the center seat of the rear seat, and
wherein the passenger support device is installed at the backrest of the center seat of the rear seat and the waist support member includes a left waist support member and a right waist support member.

15. The method of claim 14, further comprising:
displaying information to determine whether the waist support member is operated and an operation mode of the waist support member by a display portion; and
receiving the input of the user by an input portion,
wherein the operation mode includes a first operation mode and a second operation mode, the left waist support member or the right waist support member being configured to be longitudinally stretched from the backrest toward the front of the vehicle based on the vehicle rotating in the first operation mode, and the left waist support member and the right waist support member are configured to be longitudinally stretched from the backrest toward the front of the vehicle in the second operation mode.

16. The method of claim 15, further comprising:
determining whether an operation signal of a turn signal lamp and an operation signal of a steering wheel are received by the control device based on receiving the input from the user through the input portion to operate the waist support member and execute the first operation mode;
determining a rotation direction of the steering wheel according to the operation signal of the steering wheel by the control device based on a determination that both the operation signal of the turn signal lamp and the operation signal of the steering wheel are received;
allowing the right waist support member to be longitudinally stretched from the backrest toward the front of the vehicle with a predetermined variable longitudinal elongation length by the control device based on a yaw rate of the vehicle, which is sensed by a yaw rate sensor based on a determination that the steering wheel is rotated to the left; and
allowing the left waist support member to be longitudinally stretched from the backrest toward the front of the vehicle with the predetermined variable longitudinal elongation length by the control device based on the yaw rate of the vehicle sensed by the yaw rate sensor in response to a determination that the steering wheel is rotated to the right,
wherein the variable longitudinal elongation length increases as the yaw rate of the vehicle increases.

17. The method of claim 15, further comprising allowing each of the left waist support member and the right waist support member to be longitudinally stretched from the backrest toward the front of the vehicle with a predetermined fixed longitudinal elongation length by the control device based on receiving the input from the user through the input portion for operating the waist support member and executing the second operation mode.

18. The method of claim 15, further comprising not executing an elongation operation of the waist support member by the control device based on receiving the input from the user through the input portion to cancel the operation of the waist support member.

19. The method of claim 16, further comprising:
determining, by the control device, whether the steering wheel is returned to an original position of the steering wheel according to the operation signal of the steering wheel; and
allowing, by the control device, the right waist support member or the left waist support member having longitudinally stretched to be returned to the backrest based on a determination that the steering wheel is returned to the original position of the steering wheel.

20. The method of claim 17, further comprising allowing, by the control device, the left waist support member and the right waist support member having longitudinally stretched to be returned to the backrest based on receiving the input from the user through the input portion to stop the operation of the waist support member.
